(19) United States
(12) Patent Application Publication
(10) Pub. No.: US 2022/0386418 A1
(43) Pub. Date: Dec. 1, 2022

(54) DEVICE AND METHOD FOR CONTROLLING HEATER WIRE OF REAR WINDOW OF VEHICLE

(71) Applicants: HYUNDAI MOTOR COMPANY, Seoul (KR); Kia Corporation, Seoul (KR)

(72) Inventor: Cheol Han KIM, Yongin-si (KR)

(73) Assignees: HYUNDAI MOTOR COMPANY, Seoul (KR); Kia Corporation, Seoul (KR)

(21) Appl. No.: 17/498,049

(22) Filed: Oct. 11, 2021

(30) Foreign Application Priority Data
May 26, 2021 (KR) 10-2021-0067817

(51) Int. Cl. H05B 1/02; B62D 37/00; B60R 16/033; H05B 3/84

(52) U.S. Cl. CPC H05B 1/0236; B62D 37/00; B60R 16/033; H05B 3/84

(57) ABSTRACT

The present disclosure relates to a device and a method for controlling a heater wire of a rear window of a vehicle. To reduce a drag force acting on the vehicle by pushing positively charged air (containing dust) by a positive voltage induced in the heater wire, and prevent the dust from adsorbing on the rear window of the vehicle, the device includes a switch located on a connection line between an output terminal of the heater wire mounted on the rear window of the vehicle and a negative (−) terminal of a battery disposed in the vehicle, a booster for boosting a voltage output from a positive (+) terminal of the battery and supplying the boosted voltage to an input terminal of the heater wire, and a controller that controls the switch.

### CROSS-REFERENCE TO RELATED APPLICATION

This application claims the benefit of priority to Korean Patent Application No. 10-2021-0067817, filed on May 26, 2021 in the Korean Intellectual Property Office, the entire contents of which are incorporated herein by reference.

### TECHNICAL FIELD

The present disclosure relates to a technology for reducing a drag force acting on a vehicle by controlling a heater wire mounted on a rear window of the vehicle during high-speed traveling, and also preventing dust from adsorbing on the rear window of the vehicle.

### BACKGROUND

In general, a vehicle traveling at a high speed is subjected to various forces such as a pressure resistance, a viscous resistance, and an eddy resistance while passing through an air layer.

The pressure resistance generated by the air layer pressing the vehicle is usually referred to as a downforce, and serves to reduce a loss occurring in a process of changing an output of an engine into a traveling force by increasing a gripping force of a vehicle wheel. However, the air layer passing beneath a vehicle body generates a lift force for lifting the vehicle, causing a travel loss of the vehicle. The viscous resistance of the air and a vacuum state generated at the rear of the vehicle act as a drag force for pulling the vehicle back, thereby interfering with the travel of the vehicle.

Various aero parts are mounted on the vehicle to utilize a force useful for the travel of the vehicle well and cancel a force that is unfavorable to the travel of the vehicle among the various forces generated during the travel of the vehicle as such. As an example, the aero parts may include a wing-shaped spoiler for increasing the downforce, an air dam, a duct, and a skirt mounted on a bottom surface or a side surface of the vehicle to reduce the lift force, a diffuser for minimizing the drag force generated at the rear of the vehicle, and a vortex generator.

In particular, because a state of a rear portion of the vehicle traveling at the high speed becomes a vacuum state in which a density of air is lowered, the drag force that interferes with the travel of the vehicle is generated, and surrounding air is rapidly introduced to the rear portion of the vehicle to adsorb dust on a rear window of the vehicle.

Technologies for reducing the drag force acting on the vehicle using the diffuser, the vortex generator, or an aluminum tape have been proposed to date, but a technology that reduces the drag force acting on the vehicle and prevents the dust from adsorbing on the rear window of the vehicle has not been proposed.

Matters described in the background section are written to promote understanding of the background of the present disclosure, and may include matters that are not already known to those of ordinary skill in the art to which this technology belongs.

### SUMMARY

The present disclosure has been made to solve the above-mentioned problems occurring in the prior art while advantages achieved by the prior art are maintained intact.

An aspect of the present disclosure provides a device and a method for controlling a heater wire of a rear window of a vehicle that open a switch located on a connection line between an output terminal of a heater wire mounted on the rear window of the vehicle and a negative terminal of a battery disposed in the vehicle during high-speed traveling to switch a state of the heater wire to an open loop state, and boost a voltage output from a positive terminal of the battery and supply the boosted voltage to an input terminal of the heater wire, thereby reducing a drag force acting on the vehicle by pushing positively charged air (containing dust) by a positive voltage induced in the heater wire, and preventing the dust from adsorbing on the rear window of the vehicle.

The technical problems to be solved by the present inventive concept are not limited to the aforementioned problems, and any other technical problems not mentioned herein will be clearly understood from the following description by those skilled in the art to which the present disclosure pertains.

According to an aspect of the present disclosure, a device for controlling a heater wire of a rear window of a vehicle includes a switch located on a connection line between an output terminal of the heater wire mounted on the rear window of the vehicle and a negative (−) terminal of a battery disposed in the vehicle, a booster for boosting a voltage output from a positive (+) terminal of the battery and supplying the boosted voltage to an input terminal of the heater wire, and a controller that controls the switch.

In one embodiment, the controller may open the switch to switch a state of the heater wire to an open loop state when a speed of the vehicle exceeds a reference speed.

In one embodiment, the controller may maintain an off state of the switch when operating in a heater wire mode.

In one embodiment, the controller may operate in the heater wire mode when an on signal of a heater wire switch is obtained through a vehicle network or when weather information obtained through the vehicle network satisfies operating conditions of the heater wire.

In one embodiment, the booster may be a DC-DC converter.

In one embodiment, the booster may supply the voltage output from the positive (+) terminal of the battery to the input terminal of the heater wire without boosting the voltage when the battery is a high-voltage battery having an operating voltage higher than that of a 12 V battery.

According to another aspect of the present disclosure, a method for controlling a heater wire of a rear window of a vehicle includes boosting, by a booster, a voltage output from a positive (+) terminal of a battery disposed in the vehicle and supplying the boosted voltage to an input terminal of the heater wire mounted on the rear window of the vehicle, and controlling, by a controller, a switch located on a connection line between an output terminal of the heater wire and a negative (−) terminal of the battery.

In one embodiment, the controlling of the switch may include opening the switch to switch a state of the heater wire to an open loop state when a speed of the vehicle exceeds a reference speed.

In one embodiment, the controlling of the switch may include maintaining an off state of the switch when operating in a heater wire mode.

In one embodiment, the operating in the heater wire mode may include a case where an on signal of a heater wire switch is obtained through a vehicle network or a case where weather information obtained through the vehicle network satisfies operating conditions of the heater wire.

In one embodiment, the supplying of the boosted voltage to the input terminal of the heater wire may include supplying the voltage output from the positive (+) terminal of the battery to the input terminal of the heater wire without boosting the voltage when the battery is a high-voltage battery having an operating voltage higher than that of a 12 V battery.

According to another aspect of the present disclosure, a device for controlling a heater wire of a rear window of a vehicle includes a high-voltage battery for supplying a positive (+) voltage to an input terminal of the heater wire mounted on the rear window of the vehicle, a switch located on a connection line between an output terminal of the heater wire and a negative (−) terminal of the high-voltage battery, and a controller that controls the switch.

In one embodiment, the controller may open the switch to switch a state of the heater wire to an open loop state when a speed of the vehicle exceeds a reference speed.

In one embodiment, the controller may maintain an off state of the switch when operating in a heater wire mode.

In one embodiment, the controller may operate in the heater wire mode when an on signal of a heater wire switch is obtained through a vehicle network or when weather information obtained through the vehicle network satisfies operating conditions of the heater wire.

In one embodiment, the device may further include a circuit breaker for opening the switch when an overcurrent, which is a current higher than a reference current range for the heater wire, flows through the heater wire.

According to another aspect of the present disclosure, a method for controlling a heater wire of a rear window of a vehicle includes supplying, by a high-voltage battery, a positive (+) voltage to an input terminal of the heater wire mounted on the rear window of the vehicle, and controlling, by a controller, a switch located on a connection line between an output terminal of the heater wire and a negative (−) terminal of the high-voltage battery.

In one embodiment, the controlling of the switch may include opening the switch to switch a state of the heater wire to an open loop state when a speed of the vehicle exceeds a reference speed.

In one embodiment, the controlling of the switch may include maintaining an off state of the switch when operating in a heater wire mode.

In one embodiment, the operating in the heater wire mode may include a case where an on signal of a heater wire switch is obtained through a vehicle network or a case where weather information obtained through the vehicle network satisfies operating conditions of the heater wire.

In one embodiment, the method may further include opening, by a circuit breaker, the switch when an overcurrent, which is a current higher than a reference current range for the heater wire, flows through the heater wire.

### BRIEF DESCRIPTION OF THE DRAWINGS

The above and other objects, features and advantages of the present disclosure will be more apparent from the following detailed description taken in conjunction with the accompanying drawings:

FIG. 1 is a block diagram of a rear window heater wire control device of a vehicle according to an exemplary embodiment of the present disclosure;

FIG. 2 is an exemplary view of a triboelectric series used in each exemplary embodiment of the present disclosure;

FIG. 3 is a detailed structural diagram of a rear window heater wire control device of a vehicle according to an exemplary embodiment of the present disclosure;

FIG. 4 is an exemplary view illustrating a principle that a controller equipped in a rear window heater wire control device of a vehicle according to each exemplary embodiment of the present disclosure reduces a drag force and prevents adsorption of dust;

FIG. 5 is a flowchart of a rear window heater wire control method of a vehicle according to an exemplary embodiment of the present disclosure;

FIG. 6 is a block diagram of a rear window heater wire control device of a vehicle according to another exemplary embodiment of the present disclosure;

FIG. 7 is a flowchart of a rear window heater wire control method of a vehicle according to another exemplary embodiment of the present disclosure; and

FIG. 8 is a block diagram showing a computing system for executing a rear window heater wire control method of a vehicle according to each exemplary embodiment of the present disclosure.

### DETAILED DESCRIPTION

Hereinafter, some embodiments of the present disclosure will be described in detail with reference to the exemplary drawings. In adding the reference numerals to the components of each drawing, it should be noted that the identical or equivalent component is designated by the identical numeral even when they are displayed on other drawings. Further, in describing the embodiment of the present disclosure, a detailed description of the related known configuration or function will be omitted when it is determined that it interferes with the understanding of the embodiment of the present disclosure.

In describing the components of the embodiment according to the present disclosure, terms such as first, second, A, B, (a), (b), and the like may be used. These terms are merely intended to distinguish the components from other components, and the terms do not limit the nature, order or sequence of the components. Unless otherwise defined, all terms including technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

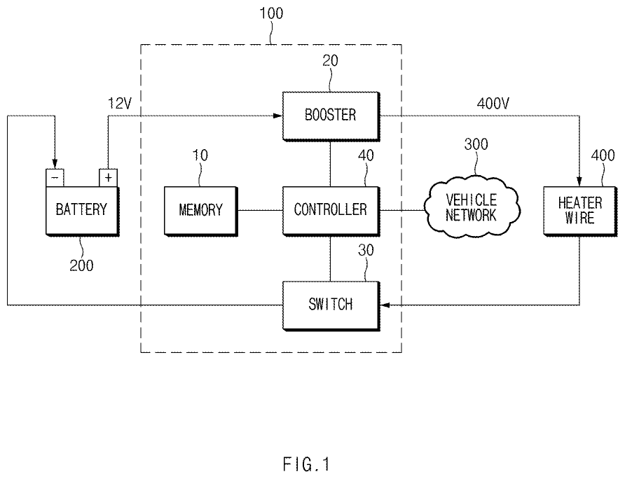

FIG. 1 is a block diagram of a rear window heater wire control device of a vehicle according to an exemplary embodiment of the present disclosure.

As shown in FIG. 1, a rear window heater wire control device 100 of a vehicle according to an exemplary embodiment of the present disclosure may include a memory 10, a booster 20, a switch 30, and a controller 40. In this connection, depending on a scheme of implementing the rear window heater wire control device 100 of the vehicle according to an exemplary embodiment of the present disclosure, components may be coupled to each other to be implemented as one component, or some components may be omitted.

In addition, as shown in FIG. 1, a battery 200, which is a low-voltage battery for supplying power to a heater wire 400, may supply power to various electric devices disposed in the vehicle. A vehicle network 300 may include a controller area network (CAN), a controller area network with flexible data-rate (CAN FD), a local interconnect network (LIN), a FlexRay, a media oriented systems transport (MOST), an Ethernet, and the like. In this connection, the CAN may include a powertrain CAN (P-CAN), a multimedia CAN (M-CAN), a body CAN (B-CAN), and the like. In this connection, the P-CAN may include vehicle speed information, the M-CAN may include weather information (an outdoor air temperature, a rainfall, a snowfall, and the like), and the B-CAN may include on/off information of a heater wire switch. For reference, the heater wire switch, which is a manual switch operated by manipulation of a user, may generate a heater wire switch on signal or a heater wire switch off signal.

Each of the components will be described. First, the memory 10 may store various logics, algorithms, and programs required in a process of opening the switch 30 located on a connection line between an output terminal “C” of the heater wire 400 mounted on a rear window of the vehicle and a negative (−) terminal of the battery 200 disposed in the vehicle during high-speed traveling to switch a state of the heater wire 400 to an open loop state (that is, form a magnetic field using the heater wire 400), and boosting a voltage output from a positive (+) terminal of the battery 200 and supplying the boosted voltage to an input terminal “A” of the heater wire 400.

Such memory 10 may include at least one type of recording media (storage media) of a memory of a flash memory type, a hard disk type, a micro type, a card type (e.g., a secure digital card (SD card) or an eXtream digital card (XD card)), and the like, and/or a memory of a random access memory (RAM), a static RAM (SRAM), a read-only memory (ROM), a programmable ROM (PROM), an electrically erasable PROM (EEPROM), a magnetic RAM (MRAM), a magnetic disk, and an optical disk type.

The booster 20 may be implemented as, for example, a DC-DC converter (a boost converter), and may boost an output voltage (e.g., 12 V) of the battery 200 to a reference voltage (e.g., 400 V).

The booster 20 may supply an output voltage (e.g., 400 V) of a high-voltage battery 600 to the input terminal of the heater wire 400 without boosting the output voltage. The high-voltage battery 600 according to one exemplary embodiment of the present disclosure may have operating voltages higher than the operating voltage of a 12 V battery.

The switch 30, which is an electronic switch, may switch the state of the heater wire 400 from the ‘open loop’ state to a ‘closed loop’ state when being turned on (opened) by control of the controller 40, and may switch the state of the heater wire 400 from the ‘closed loop’ state to the ‘open loop’ state when being turned off.

The controller 40 may perform overall control such that each of the components may perform a function thereof normally. Such controller 40 may be implemented in a form of hardware, or may be implemented in a form of software, or may be implemented in a form of a combination of the hardware and the software. Preferably, the controller 40 may be implemented as a microprocessor, but may not be limited thereto.

In particular, the controller 40 may perform various control in the process of opening the switch 30 located on the connection line between the output terminal “C” of the heater wire 400 mounted on the rear window of the vehicle and the negative (−) terminal of the battery 200 disposed in the vehicle during the high-speed traveling to switch the state of the heater wire 400 to the open loop state (that is, form the magnetic field using the heater wire 400), and boosting the voltage output from the positive (+) terminal of the battery 200 and supplying the boosted voltage to the input terminal “A” of the heater wire 400.

When the state of the heater wire 400 is switched to the open loop state by the controller 40 as such, because a current from the battery 200 is not converted into thermal energy by the heater wire 400, loss of energy may be prevented. In addition, a drag force acting on the vehicle may be reduced by pushing air positively charged because of friction with the vehicle in the high-speed traveling rearward of the vehicle, and dust may be prevented from adsorbing on the rear window of the vehicle.

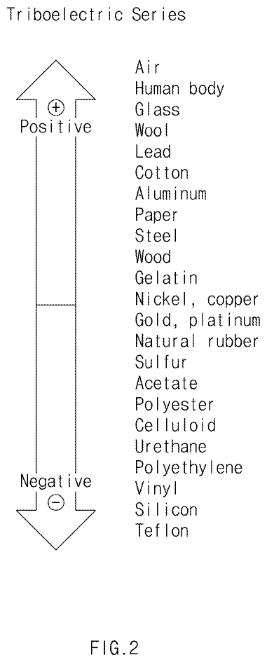

Hereinafter, an operation of the controller 40 will be described in detail with reference to FIGS. 2 to 4.

FIG. 2 is an exemplary view of a triboelectric series used in each embodiment of the present disclosure. For reference, when friction occurs between materials with different electrification rates, because of a difference in an electron-attracting force between the two materials, the two materials are charged with different polarities. Such phenomenon is referred to as static electricity resulted from triboelectricification.

As shown in FIG. 2, in the triboelectric series used in an embodiment of the present disclosure, when friction occurs between air and a vehicle body (steel), the air is positively charged and the vehicle body is negatively charged. In this connection, dust contained in the air is also positively charged. For reference, the positively charged air and the dust are naturally discharged in atmosphere after a certain period of time, and the charging effect disappears. However, because a time for the positively charged air and the dust to reach the rear window of the vehicle is very short, the charging effect of the air and the dust is maintained in a process in which a positive voltage induced in the heater wire 400 pushes out the positively charged air and the dust.

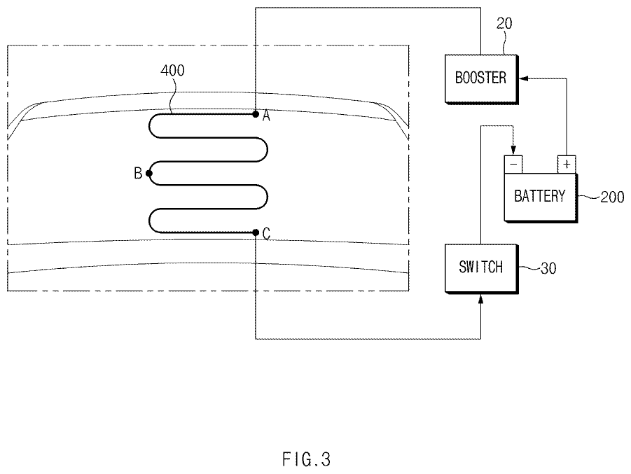

FIG. 3 is a detailed structural diagram of a rear window heater wire control device of a vehicle according to an exemplary embodiment of the present disclosure.

As shown in FIG. 3, the booster 20 is connected to the input terminal “A” of the heater wire 400, and the switch 30 is connected to the output terminal “C” of the heater wire 400. In this connection, when the switch 30 is opened, because the state of the heater wire 400 becomes the open loop state, a voltage at a point “A”, a voltage at a point “B”, and a voltage at a point “C” become all 400 V. That is, no current flows, so that no energy is consumed.

However, when the switch 30 is not opened (when the heater wire 400 operates for a purpose of securing a rear view), because the state of the heater wire 400 becomes the closed loop state, the voltage at the point “A” becomes 400 V, the voltage at the point “B” becomes 200 V, and the voltage at the point “C” becomes 0 V. That is, because the current is converted into the thermal energy by the heater wire 400, the energy is consumed. In this connection, the controller 40 may operate the heater wire 400 for a purpose of securing the rear view of the vehicle based on whether the heater wire switch operates or the weather information. That is, the controller 40 may operate the heater wire 400 in a heater wire mode, which is an original purpose.

When a speed of the vehicle obtained through the vehicle network 300 exceeds a reference speed, the controller 40 may open the switch 30 to use the heater wire 400 to reduce the drag force and prevent the dust adsorption on the rear window. In this connection, the controller 40 may control the booster 20 to boost the voltage of the battery to the reference voltage.

When the on signal of the heater wire switch is obtained through the vehicle network 300, the controller 40 may operate the heater wire 400 without opening the switch 30 to use the heater wire 400 for the purpose of securing the rear view of the user.

When the weather information obtained through the vehicle network 300 satisfies operating conditions of the heater wire 400, the controller 40 may operate the heater wire 400 without opening the switch 30 to use the heater wire 400 for the purpose of securing the rear view of the user. In this connection, the operating conditions of the heater wire 400 may include, for example, the outdoor air temperature equal to or lower than a reference temperature, the rainfall equal to or greater than a reference rainfall, and the like.

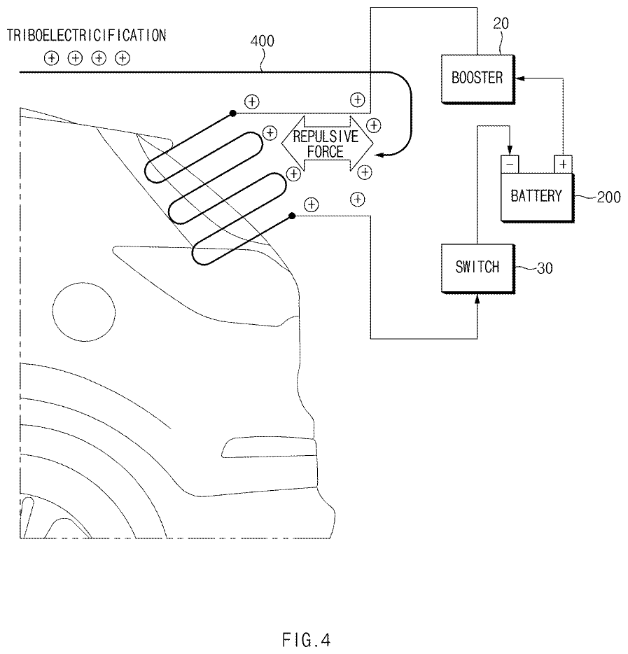

FIG. 4 is an exemplary view illustrating a principle that a controller equipped in a rear window heater wire control device of a vehicle according to each exemplary embodiment of the present disclosure reduces a drag force and prevents adsorption of dust.

As shown in FIG. 4, when the controller 40 opens the switch 30 to switch the state of the heater wire 400 to the open loop state, the positive (+) voltage induced in the heater wire 400 pushes positive (+) charged air 410 rearward of the vehicle by friction with the vehicle in the high-speed traveling (generates a repulsive force) to not only reduce the drag force acting on the vehicle, but also prevent the dust from adsorbing on the rear window of the vehicle.

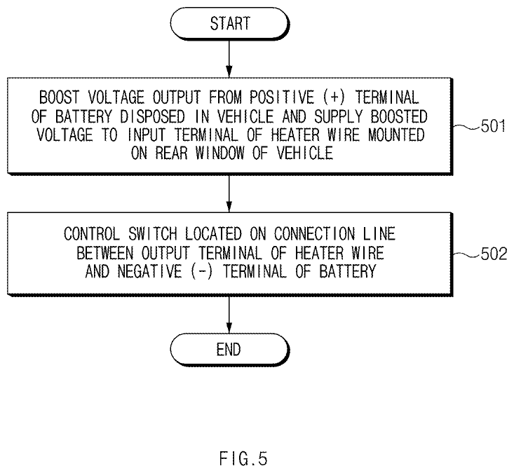

FIG. 5 is a flowchart of a rear window heater wire control method of a vehicle according to an exemplary embodiment of the present disclosure.

First, the booster 20 boosts the voltage output from the positive (+) terminal of the battery 200 disposed in the vehicle and supplies the boosted voltage to the input terminal of the heater wire 400 mounted on the rear window of the vehicle (501).

Thereafter, the controller 40 controls the switch 30 located on the connection line between the output terminal of the heater wire 400 and the negative (−) terminal of the battery 200 (502). In this connection, when the speed of the vehicle exceeds the reference speed, the controller 40 may open the switch 30 to switch the state of the heater wire 400 to the open loop state.

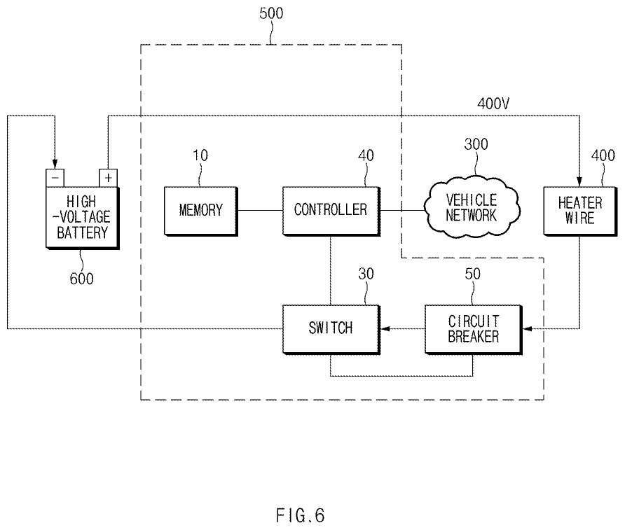

FIG. 6 is a block diagram of a rear window heater wire control device of a vehicle according to another exemplary embodiment of the present disclosure. For better understanding, the same reference numeral is assigned to a component that performs the same function as the component shown in FIG. 1.

As shown in FIG. 6, a rear window heater wire control device 500 of the vehicle according to another exemplary embodiment of the present disclosure may include the memory 10, the switch 30, the controller 40, and a circuit breaker 50. In this connection, depending on a scheme of implementing the rear window heater wire control device 500 of the vehicle according to an exemplary embodiment of the present disclosure, components may be coupled to each other to be implemented as one component, or some components may be omitted.

Each of the components will be described. First, the memory 10 may store various logics, algorithms, and programs required in a process of opening the switch 30 located on a connection line between the output terminal “C” of the heater wire 400 mounted on the rear window of the vehicle and a negative (−) terminal of the high-voltage battery 600 disposed in the vehicle during the high-speed traveling to switch the state of the heater wire 400 to the open loop state (that is, form the magnetic field using the heater wire 400), and supplying a voltage output from a positive (+) terminal of the high-voltage battery 600 to the input terminal “A” of the heater wire 400.

Such memory 10 may include at least one type of the recording media (the storage media) of the memory of the flash memory type, the hard disk type, the micro type, the card type (e.g., the secure digital card (SD card) or the eXtream digital card (XD card)), and the like, and/or the memory of the random access memory (RAM), the static RAM (SRAM), the read-only memory (ROM), the programmable ROM (PROM), the electrically erasable PROM (EEPROM), the magnetic RAM (MRAM), the magnetic disk, and the optical disk type.

The switch 30, which is the electronic switch, may switch the state of the heater wire 400 from the ‘open loop’ state to the ‘closed loop’ state when being turned on (opened) by the control of the controller 40, and may switch the state of the heater wire 400 from the ‘closed loop’ state to the ‘open loop’ state when being turned off.

The controller 40 may perform the overall control such that each of the components may perform the function thereof normally. Such controller 40 may be implemented in a form of hardware, or may be implemented in the form of software, or may be implemented in the form of the combination of the hardware and the software. Preferably, the controller 40 may be implemented as a microprocessor (e.g., computer, processor, CPU, ASIC, circuitry, logic circuits, etc.), but may not be limited thereto.

In particular, the controller 40 may perform various control in a process of opening the switch 30 located on the connection line between the output terminal “C” of the heater wire 400 mounted on the rear window of the vehicle and the negative (−) terminal of the high-voltage battery 600 disposed in the vehicle during the high-speed traveling to switch the state of the heater wire 400 to the open loop state (that is, form the magnetic field using the heater wire 400), and supplying the voltage output from the positive (+) terminal of the high-voltage battery 600 to the input terminal “A” of the heater wire 400.

When the state of the heater wire 400 is switched to the open loop state by the controller 40 as such, because the current from the high-voltage battery 600 is not converted into the thermal energy by the heater wire 400, the loss of energy may be prevented. In addition, the drag force acting on the vehicle may be reduced by pushing the air positively charged because of the friction with the vehicle in the high-speed traveling rearward of the vehicle, and the dust may be prevented from adsorbing on the rear window of the vehicle.

The circuit breaker 50 may prevent fire by opening the switch 30 when an overcurrent, which is a current higher than a reference current range for the heater wire, flows to the heater wire 400.

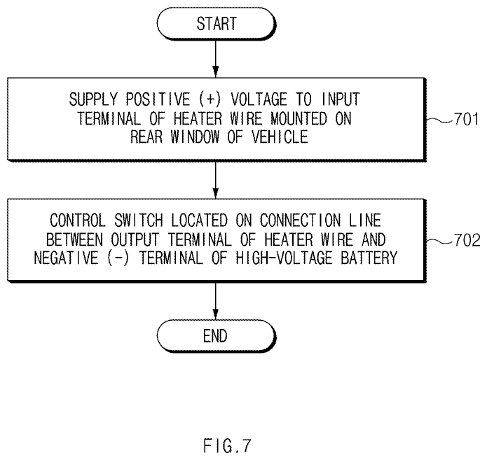

FIG. 7 is a flowchart of a rear window heater wire control method of a vehicle according to another exemplary embodiment of the present disclosure.

First, the high-voltage battery 600 supplies the positive (+) voltage to the input terminal of the heater wire 400 mounted on the rear window of the vehicle (701).

Thereafter, the controller 40 controls the switch 30 located on the connection line between the output terminal of the heater wire 400 and the negative (−) terminal of the high-voltage battery 600 (702). In this connection, when the speed of the vehicle exceeds the reference speed, the controller 40 may open the switch 30 to switch the state of the heater wire 400 to the open loop state.

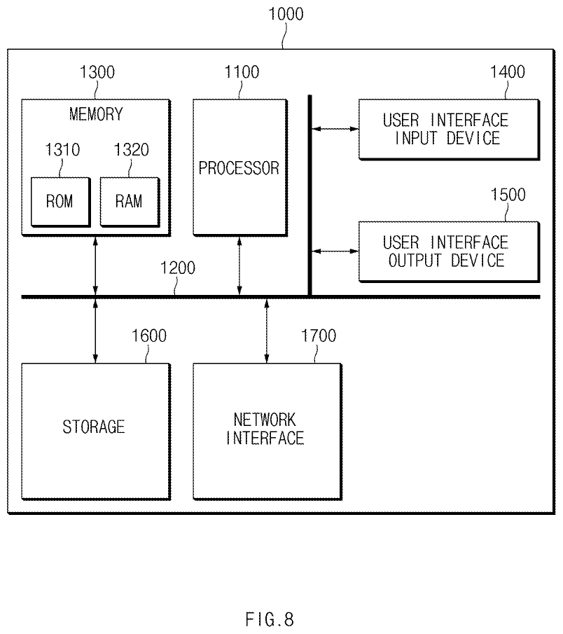

FIG. 8 is a block diagram showing a computing system for executing a rear window heater wire control method of a vehicle according to each exemplary embodiment of the present disclosure.

Referring to FIG. 8, the rear window heater wire control method of the vehicle according to each exemplary embodiment of the present disclosure may also be implemented through a computing system. A computing system 1000 may include at least one processor 1100, a memory 1300, a user interface input device 1400, a user interface output device 1500, storage 1600, and a network interface 1700 connected via a system bus 1200.

The processor 1100 may be a central processing unit (CPU) or a semiconductor device that performs processing on commands stored in the memory 1300 and/or the storage 1600. The memory 1300 and the storage 1600 may include various types of volatile or non-volatile storage media. For example, the memory 1300 may include a ROM (Read Only Memory) 1310 and a RAM (Random Access Memory) 1320.

Thus, the operations of the method or the algorithm described in connection with the embodiments disclosed herein may be embodied directly in hardware or a software module executed by the processor 1100, or in a combination thereof. The software module may reside on a storage medium (that is, the memory 1300 and/or the storage 1600) such as a RAM, a flash memory, a ROM, an EPROM, an EEPROM, a register, a hard disk, a solid state drive (SSD), a removable disk, and a CD-ROM. The exemplary storage medium is coupled to the processor 1100, which may read information from, and write information to, the storage medium. In another method, the storage medium may be integral with the processor 1100. The processor and the storage medium may reside within an application specific integrated circuit (ASIC). The ASIC may reside within the user terminal. In another method, the processor and the storage medium may reside as individual components in the user terminal.

The description above is merely illustrative of the technical idea of the present disclosure, and various modifications and changes may be made by those skilled in the art without departing from the essential characteristics of the present disclosure.

Therefore, the embodiments disclosed in the present disclosure are not intended to limit the technical idea of the present disclosure but to illustrate the present disclosure, and the scope of the technical idea of the present disclosure is not limited by the embodiments. The scope of the present disclosure should be construed as being covered by the scope of the appended claims, and all technical ideas falling within the scope of the claims should be construed as being included in the scope of the present disclosure.

The device and the method for controlling the heater wire of the rear window of the vehicle according to an exemplary embodiment of the present disclosure as described above may open the switch located on the connection line between the output terminal of the heater wire mounted on the rear window of the vehicle and the negative terminal of the battery disposed in the vehicle during the high-speed traveling to switch the state of the heater wire to the open loop state, and boost the voltage output from the positive terminal of the battery and supply the boosted voltage to the input terminal of the heater wire, thereby reducing the drag force acting on the vehicle by pushing the positively charged air (containing the dust) by the positive voltage induced in the heater wire, and preventing the dust from adsorbing on the rear window of the vehicle.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A device for controlling a heater wire of a rear window of a vehicle, the device comprising:
a switch located on a connection line between an output terminal of the heater wire mounted on the rear window of the vehicle and a negative (−) terminal of a battery disposed in the vehicle;
a booster for boosting a voltage output from a positive (+) terminal of the battery and supplying the boosted voltage to an input terminal of the heater wire; and
a controller configured to control the switch.

2. The device of claim 1, wherein the controller opens the switch to switch a state of the heater wire to an open loop state when a speed of the vehicle exceeds a reference speed.

3. The device of claim 1, wherein the controller maintains an off state of the switch when the controller is operating in a heater wire mode.

4. The device of claim 3, wherein the controller is configured to operate in the heater wire mode when an on signal of a heater wire switch is obtained through a vehicle network or when weather information obtained through the vehicle network satisfies operating conditions of the heater wire.

5. The device of claim 1, wherein the booster is a DC-DC converter.

6. The device of claim 1, wherein the booster supplies the voltage output from the positive (+) terminal of the battery to the input terminal of the heater wire without boosting the voltage when the battery is a high-voltage battery having an operating voltage higher than that of a 12 V battery.

7. The device of claim 6, further comprising:
a circuit breaker configured to open the switch when an overcurrent, which is a current higher than a reference current range for the heater wire, flows through the heater wire.

8. A method for controlling a heater wire of a rear window of a vehicle, the method comprising:
boosting, by a booster, a voltage output from a positive (+) terminal of a battery disposed in the vehicle and supplying the boosted voltage to an input terminal of the heater wire mounted on the rear window of the vehicle; and
controlling, by a controller, a switch located on a connection line between an output terminal of the heater wire and a negative (−) terminal of the battery.

9. The method of claim 8, wherein the controlling of the switch includes:
opening the switch to switch a state of the heater wire to an open loop state when a speed of the vehicle exceeds a reference speed.

10. The method of claim 8, wherein the controlling of the switch includes:
maintaining an off state of the switch when operating in a heater wire mode.

11. The method of claim 10, wherein the operating in the heater wire mode includes a case where an on signal of a heater wire switch is obtained through a vehicle network or a case where weather information obtained through the vehicle network satisfies operating conditions of the heater wire.

12. The method of claim 8, wherein the booster is a DC-DC converter.

13. The method of claim 8, wherein the supplying of the boosted voltage to the input terminal of the heater wire includes:
supplying the voltage output from the positive (+) terminal of the battery to the input terminal of the heater wire without boosting the voltage when the battery is a high-voltage battery having an operating voltage higher than that of a 12 V battery.

14. The method of claim 13, further comprising:
opening, by a circuit breaker, the switch when an overcurrent, which is a current higher than a reference current range for the heater wire, flows through the heater wire.
